(19) United States
(12) Patent Application Publication
(10) Pub. No.: US 2026/0303507 A1
(43) Pub. Date: Oct. 1, 2026

(54) METHODS AND APPARATUSES FOR NETWORK NODES HOSTING DIGITAL TWIN

(71) Applicant: Telefonaktiebolaget LM Ericsson (publ), Stockholm (SE)

(72) Inventors: Junaid ANSARI, AACHEN (DE); Fedor CHERNOGOROV, ESPOO (FI)

(73) Assignee: Telefonaktiebolaget LM Ericsson (publ), Stockholm (SE)

(21) Appl. No.: 19/489,030

(22) PCT Filed: Jun. 2, 2023
(86) PCT No.: PCT/SE2023/050551

§ 371 Date: Dec. 1, 2025

(51) Int. Cl. H04L 43/55; H04L 41/147; H04L 41/5067

(52) U.S. Cl. CPC H04L 43/55; H04L 41/147; H04L 41/5067

(57) ABSTRACT

Embodiments described herein relate to methods and apparatuses for enabling interaction between a first digital twin (104) of a communications network and a second digital twin (103) of an application. A method in a first network node (101) hosting the first digital twin (104) comprises obtaining (201, 301, 606) predicted Quality of Experience, QoE, information for the application, wherein the predicted QoE information is determined utilizing a second digital twin (105) of the application; predicting (202, 302, 608), utilizing the first digital twin, a predicted network efficiency of a first network configuration for the communications network given the QoE information; and responsive to the predicted network efficiency of the first network configuration not meeting a first condition: initiating (204, 612) determining, utilizing the second digital twin, an updated application configuration, and/or determining (304, 607), utilizing the first digital twin, an updated network configuration based on the predicted QoE information.

### TECHNICAL FIELD

Embodiments described herein relate to methods and apparatuses of a network node hosting a digital twin of a communications network and a network node hosting a digital twin of an application. Further disclosed is a system, computer program, and computer program product thereof.

### BACKGROUND

A digital twin may be defined as a virtual representation of assets and processes, along with their environment and users. A digital twin my be synchronized at a specified periodicity and fidelity (see for example, Y. Wu, K. Zhang and Y. Zhang, “Digital Twin Networks: A Survey,” in IEEE Internet of Things Journal, vol. 8, no. 18, pp. 13789-13804, 2021.). Digital twins are used to plan, simulate, predict future scenarios, and optimize processes and systems using their past and current states. Digital twins have initially been targeted for complex machines and production systems. For instance, in the production of blade integrated disks (BLISKs), (a key component in jet engines to compress hot air) considerable preparation, complex and long machining, and strict quality assurance measurements are required (see for example, Z. Zhu et al., “Digital Twin-driven machining process for thin-walled part manufacturing”, Elsevier Journal of Manufacturing Systems. Vol. 59, pp. 453-466, 2021). A machine downtime due to tool breakage could halt the production process, which severely reduces production efficiency and causes extra costs. In this context, a digital twin may facilitate flexible BLISK production planning, optimization and lifecycle management. The real-time monitoring of the actual machining process also allows for accurate fault prediction and avoidance.

The use of digital twins may be extended to cellular networks especially with the growing complexity of the wireless communication system's deployment planning, management of its operations and the need for resource optimization. For example, the 5G/6G cellular systems not only target a wide range of use cases but also aim to satisfy strict performance indicators (KPIs).

### SUMMARY

It will be appreciated that, even without the use of digital twins, a communications network may be able to set configuration parameters specifically to support a specific application scenario, and that similarly an application may be able to set application configuration parameters in order to optimise functionality given a particular network configuration.

For example, the exposure of network functions to the application can be useful to adjust the application behaviour.

However, current solutions do not proactively (ahead of time) carry out prediction, simulation and eventually configuration of the network as well as the application.

An object of embodiments described herein is to provide an improved communications network. Embodiments described herein provide a framework in which a second digital twin of the application interacts with a first digital twin of the communications network, and these digital twins can then jointly predict, simulate and provide optimal solutions for both the network configuration and the application configuration. This interaction between the digital twins leads to avoiding errors and applying improved or optimal configurations for both the network and the application in a proactive manner.

Classical network optimization lacks the advantage of simulating and testing the potential solutions ahead of time in the digital space. Moreover, having no possibility to carry out any interaction between the first digital twin and the second digital twin, the application is unable to adjust or optimize itself based on predictions of the network capabilities and performance. Overall, this leads to suboptimal network performance, appearance of errors/faults in application processes and hence overall lower Quality of Experience (QoE) for the application.

According to some embodiments there is provided a method performed by a first network node wherein the first network node hosts a first digital twin of a communications network, wherein an application utilizes the communications network to operate. The method comprises obtaining predicted Quality of Experience, QoE, information for the application, wherein the predicted QoE information is determined utilizing a second digital twin of the application; predicting, utilizing the first digital twin, a predicted network efficiency of a first network configuration for the communications network given the QoE information; and responsive to the predicted network efficiency of the first network configuration not meeting a first condition: initiating determining, utilizing the second digital twin, an updated application configuration, and/or determining, utilizing the first digital twin, an updated network configuration based on the predicted QoE information.

According to some embodiments there is provided a method performed by a second network node wherein the second network node hosts second digital twin of an application, wherein the application utilizes a communications network to operate. The method comprises obtaining predicted network information relating to the communications network, wherein the predicted network information is determined utilizing a first digital twin of the communications network; predicting, utilizing the second digital twin, a predicted Quality of Experience, QoE, metric associated with a first application configuration for the application given the predicted network information; and responsive to the predicted QoE metric not meeting a second condition: initiating determining, utilizing the first digital twin, an updated network configuration, and/or determining, utilizing the second digital twin, an updated application configuration based on the predicted network information.

According to some embodiments there is provided a first network node wherein the first network node is configured to host a first digital twin of a communications network, wherein an application is configured to utilize the communications network to operate. The first network node comprises processing circuitry configured to cause the first network node to: obtain predicted Quality of Experience, QoE, information for the application, wherein the predicted QoE information is determined utilizing a second digital twin of the application; predict, utilizing the first digital twin, a predicted network efficiency of a first network configuration for the communications network given the QoE information; and responsive to the predicted network efficiency of the first network configuration not meeting a first condition: initiate determining, utilizing the second digital twin, an updated application configuration, and/or determine, utilizing the first digital twin, an updated network configuration based on the predicted QoE information.

According to some embodiments there is provided a second network node, wherein the second network node is configured to host second digital twin of an application, wherein the application is configured to utilize a communications network to operate. The second network node comprises processing circuitry configured to cause the second network node to: obtain predicted network information relating to the communications network, wherein the predicted network information is determined utilizing a first digital twin of the communications network; predict, utilizing the second digital twin, a predicted Quality of Experience, QoE, metric associated with a first application configuration for the application given the predicted network information; and responsive to the predicted QoE metric not meeting a second condition: initiate determining, utilizing the first digital twin, an updated network configuration, and/or determine, utilizing the second digital twin, an updated application configuration based on the predicted network information.

According to some embodiments there is provided a computer program comprising instructions which, when executed on at least one processor, cause the at least one processor to carry out a method as described above.

According to some embodiments there is provided a carrier containing a computer program as described above, wherein the carrier comprises one of an electronic signal, optical signal, radio signal or computer readable storage medium.

According to some embodiments there is provided a computer program product comprising non transitory computer readable media having stored thereon a computer program as described above.

For the purposes of the present disclosure, the term “ML model” encompasses within its scope the following concepts:
Machine Learning algorithms, comprising processes or instructions through which data may be used in a training process to generate a model artefact for performing a given task, or for representing a real world process or system;
the model artefact that is created by such a training process, and which comprises the computational architecture that performs the task; and
the process performed by the model artefact in order to complete the task. References to “ML model”, “model”, model parameters”, “model information”, etc., may thus be understood as relating to any one or more of the above concepts encompassed within the scope of “ML model”.

### BRIEF DESCRIPTION OF DRAWINGS

For a better understanding of the embodiments of the present disclosure, and to show how it may be put into effect, reference will now be made, by way of example only, to the accompanying drawings, in which:

FIG. 1 illustrates an example system comprising a network node according to some embodiments;

FIG. 2 illustrates a method performed by a first network node wherein the first network node hosts a first digital twin of a communications network, wherein an application utilizes the communications network to operate;

FIG. 3 illustrates an example implementation of the method of FIG. 2;

FIG. 4 illustrates a method 400 performed by a second network node wherein the second network node hosts second digital twin of an application, wherein the application utilizes a communications network;

FIG. 5 illustrates an example implementation of the method of FIG. 4;

FIG. 6 illustrates an example implementation of the methods of FIGS. 2 and 4;

FIG. 7 illustrates an network node comprising processing circuitry (or logic);

FIG. 8 is a block diagram illustrating a first network node 800 according to some embodiments;

FIG. 9 is a block diagram illustrating a second network node according to some embodiments.

### DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Certain aspects of the present disclosure and their embodiments may provide solutions to these or other challenges. The steps of any methods disclosed herein do not have to be performed in the exact order disclosed, unless a step is explicitly described as following or preceding another step and/or where it is implicit that a step must follow or precede another step.

Particular embodiments are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

In embodiments described herein, examples are given that relate to cellular communication systems such as 5G and 6G by way of example. It will be appreciated that embodiments described herein are equally applicable to any other (for example, wireless) communication system such as Wi-Fi.

In embodiments described herein focus is made on concrete examples from factory automation and smart manufacturing. However, it will be appreciated that embodiments described herein may also be applied to other 5G/6G verticals, where the use of digital twins is useful for a target use-case.

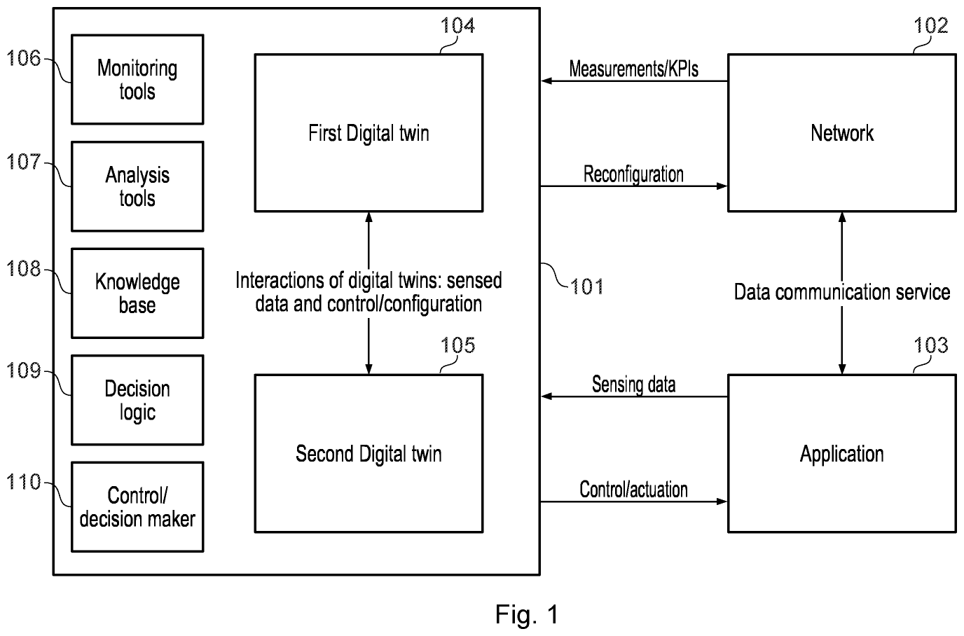

FIG. 1 illustrates an example system 100 comprising a network node 101 according to some embodiments. The network node 101 may comprise a a centrally network node or distributed computer entities. The network node may be located in an edge cloud computing environment for example, in a factory cloud and/or a content server, for example, behind the core network. The network node is in communication with a communications network 102 and an application 103. The application 103 may be implementing an application process that utilises the communications network 102 to operate. The factory may comprise a factory application. The application process may for example comprise a Bladed Integrated Disk (BLISK) process, an Autonomous Mobile Robot (AMR) related process or an Extended Reality (XR) application process. Herein the term application may be used to encompass the hardware (e.g. devices, components, interfaces, factory assets etc) that are being used to perform an application process (e.g. BLISK), as well as the application process that is being performed itself. A digital twin of an application may therefore represent the various hardware components implementing the application process as well as the states of the application process being performed.

In this example, the network node 101 is hosting a first digital twin 104 of a communications network 102 and a second digital twin 105 of the application. However, in some examples the first digital twin 104 and the second digital twin 105 are hosted on different network nodes that communicate over an interface (e.g. a first network node and a second network node).

The first digital twin 104 and the second digital twin 105 may be influenced, trained or generated by one or more logical blocks in the network node 101. For example, the network node 101 may comprise monitoring tools 106, analysis tools 107, a knowledge base 108, decision logic 109, and a control/decision block 110.

The monitoring tools 106 may be utilized for the communications network 102 to expose to the first digital twin 104 information such as service interfaces, measured KPIs and the current network state. Similarly, the monitoring tools may be used for the factor components/assets to expose relevant information such as a robot or machine exposing sensor data and other application state information. The first digital twin 104 may be updated based on the information monitored in the communications network 102 and the second digital twin 105 may be updated based on the information monitored from the application 103.

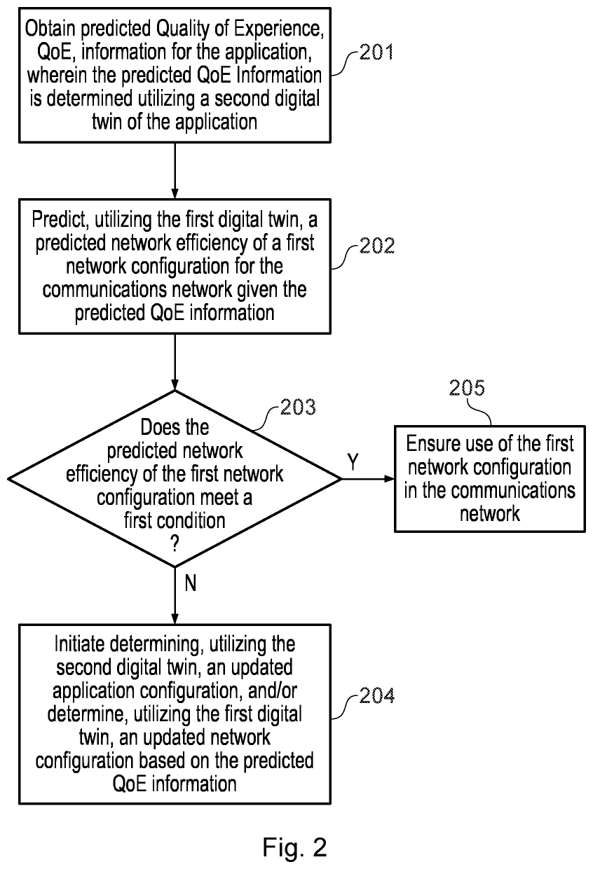

The analysis tools 107 allow for interpretation of the monitored information from both the communications network 102 and the application 103, and for learning from the existing knowledge base 108. The existing knowledge base 108 may comprise stored previous information monitored from the communications network 102 and the application 103. The decision logic 109 recommends any network reconfiguration or process control/actuation amendments, which may then be executed by the control and decision block 110. The decision logic 109 may perform any one or more of the decisions described herein (for example in the methods described later with reference to FIGS. 2 to 6).

FIG. 1 also illustrates bidirectional interaction and information exchange between the first digital twin 104 and the second digital twin 105. It is worth noting that based on the information exposed from the first digital twin relating to, for example a predicted performance of the network and/or predicted network capabilities, the second digital twin 105 may potentially adjust the control of the application 103 to meet the communication service capabilities offered by the communications network 102.

Similarly, based on predicted Quality of Experience, QoE, information provided by the second digital twin 105 to the first digital twin 104, the first digital twin 104 may adapt the network configuration.

The system 100 provides a framework that allows network (re)configuration and process control jointly based on information exchanged between the first digital twin 104 and the second digital twin 105.

By sharing information between the first digital twin 104 and the second digital twin 105 In embodiments a more optimal use of network resources may be achieved as well as enabling adjusted of factory processes so as to increase the production efficiency. The interaction between the first digital twin and the second digital twin allows for the understanding of the current and the future possible states of the twinned systems.

The interaction between the first digital twin and the second digital twin allows for proactive cooperation between the twinned systems (i.e., ahead of time in digital space) and for joint predictions and simulations of future scenarios. Accordingly, the twinned systems may be able to adjust the network configuration as well as adjust factory processes so as to increase/improve the production efficiency.

FIG. 2 illustrates a method performed by a first network node wherein the first network node hosts a first digital twin of a communications network, wherein an application utilizes the communications network to operate.

The method 200 is performed by a first network node, which may comprise a physical or virtual node, and may be implemented in a computing device or server apparatus and/or in a virtualized environment, for example in a cloud, edge cloud or fog deployment. The first network node may comprise the network node 101 of FIG. 1 hosting the first digital twin 104.

In step 201 the method comprises obtaining predicted Quality of Experience, QoE, information for the application, wherein the predicted QoE information is determined utilizing a second digital twin of the application. It will be appreciated that in some embodiments, the second digital twin is hosted on a second network node. In these examples step 201 may comprise receiving, from the second network node, the predicted QoE information for the application.

Quality of Experience (QoE) may refer the degree of delight or annoyance of a user of the application. The concept of “QoE” originates from human oriented evaluations, indicating a range of possible operation points. For industries, QoE may be expressed as the perceived service quality. QUE indicates the level of satisfaction of the connectivity service consumer, i.e., owner of the industrial solution. This satisfaction may be, for instance, in the form of acceptable number of production line stops or slow-downs. Therefore, meeting QoE requirements implies fulfillment of user expectations with respect to the utility and/or enjoyment of the application in the light of the user's personality and current state.

It will be appreciated that there may be a difference between Quality of Service (QoS) and QoE is that the former is typically focused on the physical properties of a communication service, whilst the latter relates to an application-level satisfaction perceived by the consumer of the communication service. Considering voice communication, an average latency of 100 ms may be a QoS characteristic, but dissatisfaction caused by the delayed packets may be the QoE. However, it will also be appreciated that a QoS metric may be indicative of an eventual QoE metric for an application. Therefore, herein the term QoE metric may comprise any metric that may be considered indicative of an eventual QoE of a user of an application. In other words, the QoE metric may comprise the average latency itself as the value of this metric may be considered to have an effect of the eventual QoE of the user of the application.

The predicted QoE information may relate to future states of the application given a current network configuration being implemented by the communications network. For example, the predicted QoE information may comprise a prediction that, given a current network configuration, the application will not fulfil a QoE requirement of the application. It will be appreciated that the predicted QoE information may indicate application requirements depending upon the upcoming application scenarios ahead of time in the digital space.

The predicted QoE information may additionally or alternatively comprise one or more of:
a predicted network traffic profile for the application (for example, packet sizes, packet generation frequency, arrival behavior (periodic, event based, mixed));
one or more Quality of Service, QoS, requirements of the application (for example, latency, reliability or throughput requirements);
a prediction of number of devices and/or connections to the communications network within the application;
predicted locations of one or more devices within the application;
predicted mobility patterns of one or more devices within the application; and one or more planned changes to the application.

It will be appreciated that the predicted QoE information may comprise QoS requirements for individual UEs or connections within the application, and at the same time predicted performance metrics for the application.

In step 202 the method comprises predicting, utilizing the first digital twin, a predicted network efficiency of a first network configuration for the communications network given the QoE information.

The first network configuration may comprise one or more parameter settings of the communications network such as, for example, transmit power of one or more network nodes, a Block Error Rate (BLER) target, a configuration of redundant transmissions (e.g. Packet Data Convergence Protocol (PDCP) duplication or Fram Replication and Elimination for Reliability (FRER)), etc.

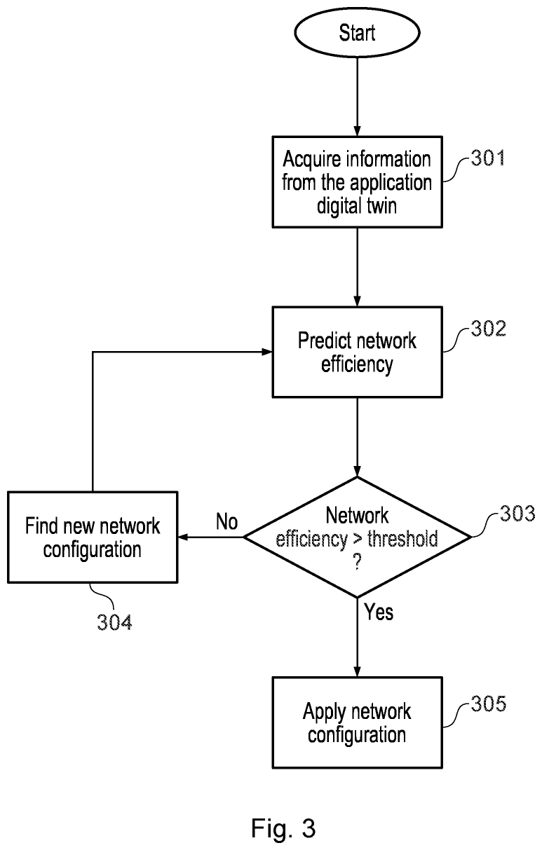

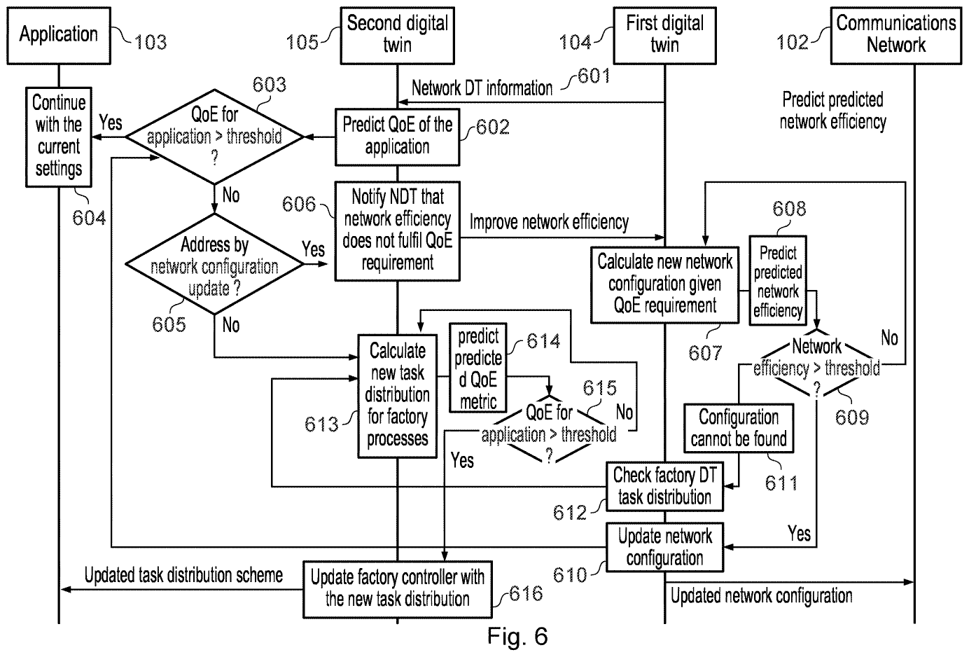

In some examples, the first network configuration comprises a current network configuration currently implemented in the communications network 102 (as will be described in more detail with reference to FIG. 3). However, in other examples, the network configuration may have already be updated in the first digital twin based on a trigger from the second digital twin, and the first network configuration may comprise an updated network configuration not currently implemented in the communications network 102 (as will be described in more detail with reference to FIG. 6).

The predicted network efficiency may comprise for example, a predicted resource utilization efficiency or one or more predicted key performance indicators (KPIs).

The network KPIs may comprise for example: latency in the communications network, throughput in the communications network, packet error rate in the communications network, spectrum usage in the communications network, compute power usage in the communications network; energy consumption footprint in the communications network, heat emission in the communications network, signalling overhead in the communications network.

Of course, there could be more complex functions defining the predicted network efficiency such as a weighted function of multiple KPIs (for example comprising a plurality of latency, throughput, radio resource usage, redundancy of transmissions, signaling overhead, etc.).

In step 202, the first digital twin 104 takes account of the predicted QoE information when determining the predicted network efficiency. For example, should the QoE information indicate that there is a predicted spike in the number of users in the factory at a first future time, the first digital twin 104 can take this into account when assessing the predicted throughput in the communications network for the first network configuration at that first future time.

In step 203, the method comprises initiate determining whether the predicted network efficiency of the first network configuration meets a first condition. It will be appreciated that the first condition may be user defined or application dependent. For example, the determining may in one embodiment be carried out by the first network node. In an alternative embodiment the predicted network efficiency is provided to another (e.g., a third) network node, wherein the determining whether the predicted network efficiency of the first network configuration meets a first condition is performed. The third network node may then provide the response of the determining back to the network node, i.e., the first network nodes obtains a message comprising a response weather the first network configuration meets a first condition from another network node (i.e., the third).
For example, the predicted network efficiency may comprise the predicted bandwidth consumption (i.e., radio resources utilization) to satisfy a latency target of an application indicated in the QoE information. The first condition may then comprise a threshold bandwidth consumption. The predicted bandwidth consumption may need to be less than the threshold bandwidth consumption to meet the first condition (in other words, a lower bandwidth consumption may be considered a higher network efficiency).

If in step 203 the predicted network efficiency does not meet the first condition, the method passes to step 204 in which one or more of the following is performed: initiating determining, utilizing the second digital twin, an updated application configuration, and/or determining, utilizing the first digital twin, an updated network configuration based on the predicted QoE information.

Returning to the example above, if a BLER target in the first network configuration is very conservative (e.g., 99.9999%), this means that a lot of radio resources are being consumed to meet this target, and thereby there may be too much bandwidth consumed to meet the first condition. In this case, step 205 may comprise determining an updated network configuration having a lower BLER target (e.g., 99.9% or even 99.99%), thereby allowing the bandwidth consumption in the updated network configuration to meet the first condition. In other words, it may be preferable to relax the BLER target in the updated network configuration and this way to potentially allow for the use of more spectrally efficient modulation and coding scheme (MCSs), so that the amount of consumed bandwidth (i.e., physical resources) is lower, and therefore the first condition is fulfilled. It will be appreciated that artificial intelligence or machine learning may be utilised to select various parameters of the updated network configuration in order to maximize a utility function defined by a weighted sum of different network KPIs.

In some cases, the network configuration may be preferentially adjusted over adjusting the application configuration. In these examples, step 204 may comprise determining, utilising the first digital twin, an updated network configuration based on the predicted QoE information. In other examples however, the application configuration may be preferentially adjusted over adjusting the network configuration. In these examples, step 204 may comprise: initiating determining, utilizing the second digital twin, an updated application configuration.

Where the first digital twin and the second digital are hosted in different network nodes, the step of initiating determining, utilising the second digital twin, an updated application configuration may comprise the network node transmitting a trigger to the network node hosting the second digital twin.

In some examples, the step of determining utilizing the first digital twin, an updated network configuration based on the predicted QoE information is performed using a machine learning (ML) model.

It will be appreciated that an aim of the step of determining an updated network configuration may be to find a network configuration that produces a predicted network efficiency that meets the first condition. In some examples, where the predicted QoE information comprises a prediction that, given a current network configuration the application will not fulfil a QoE requirement of the application, another aim of the step of determining an updated network configuration may be to determine an updated network configuration that is predicted to fulfil the QoE requirement of the application.

For example, as described above, the updated network configuration may be designed such that the latency requirement of the application predicted to be met.

If in step 203 the predicted network efficiency does meet the first condition, the method may pass to step 205 which comprises ensuring use of the first network configuration in the communications network. Where the first network configuration comprises a current network configuration, step 205 may comprise making no changes in response to the determination of step 203. However, where the first network configuration comprises an updated network configuration, step 205 may comprise initiating updating the current network configuration of the communications network to the first network configuration.

FIG. 3 illustrates an example implementation of the method of FIG. 2.

In step 301 the first network node obtains predicted Quality of Experience, QoE, information for the application, wherein the predicted QoE information is determined utilizing a second digital twin of the application. Step 301 comprises an example implementation of step 201 of FIG. 2.

In step 302, the first network node predicts, utilizing the first digital twin, a predicted network efficiency of a current network configuration for the communications network given the predicted QoE information. Step 302 comprises an example implementation of step 202 of FIG. 2.

In step 303 the first network node initiates determines whether the predicted network efficiency meets a first condition. In this example, the first condition comprises a threshold condition.

If the predicted network efficiency meets the first condition, the method passes to step 305 in which the current network configuration is maintained in the communications network.

If the predicted network efficiency does not meet the first condition, the method passes to step 304 in which an updated network configuration is determined.

The method then returns to step 302 in which the first network node predicts utilizing the first digital twin, a predicted network efficiency of the updated network configuration.

In step 303, the the first network node initiates determines whether the predicted network efficiency of the updated network configuration meets the first condition.

If the predicted network efficiency of the updated network configuration meets the first condition given the predicted QoE information, the method passes to step 305 in which the first network node initiates use of the updated network configuration in the communications network.

If the predicted network efficiency of the updated network configuration does not meet the first condition, the method passes back to step 304 and a new updated network configuration is determined.

If will be appreciated that the loop may continue until a suitable network configuration is found, or until a counter (counting the number of iterations of the loop that have been performed) reaches a threshold value.

It will be appreciated that the first network node may in some examples opt not to apply an updated network configuration that meets the first threshold if, for example, the updated network configuration is considered too costly to the first network node in some manner. For example, whilst the first threshold may relate to bandwidth, but the updated network configuration may be costly with regards to some other metric, for example, signaling overhead or energy consumption.

In the following, two examples (Bladed Integrated Disk (BLISK) and autonomous mobile robot (AMR)) of how the digital twin interaction logic of FIGS. 2 and 3 may be applied for network configuration and for application process control are given.

### BLISK

BLISK is regarded as a key component in jet-engines. The very high precision machining and strict quality control checks in the aviation industry leads to a significantly high percentage of the produced BLISKs being wasted. Wireless communication enables online monitoring and control in BLISK manufacturing to avoid faulty machining process, which aims at reducing the number of damaged BLISKs.

It has been identified that the digital twin of the BLISK application may help in predicting faults on the BLISK workpiece resulting from a combination of the specific vibration signatures of the thin blades, worn out milling tools, speed and angles of the milling tool, etc. The online monitoring of the key sensing data from the BLISK machine such as the vibration data, acoustic emission data, spindle speeds, temperature are sent wirelessly using a communications network in real-time for the update of the BLISK digital twin and related analysis for accurately predicting the faults to powerful edge cloud computing entities.

The communication network may also be used to provide adjustment and/or control of the machining process as indicated by the BLISK digital twin. For example, the communication network may be used to control/adjust spindle speeds, direction and angle of machining, timings, etc. to avoid chatter marks and other anomalies on the BLISK being produced.

The monitoring of sensing data and controlling of the machines involves stringent communication demands. The traffic generated in the uplink and the downlink directions are directly dependent upon the monitoring and control procedures executed in the BLISK use case. As such, the communication system is not currently prepared to address the sporadic/instantaneous demands efficiently.

In this context, the use of a first digital twin of the communications network allows appropriate network configuration in advance based on the predicted traffic demand and quality of service requirements at the given state of the workpiece for the BLISK use case. It is only through a well-orchestrated interaction between the second digital twin of the BLISK and the first digital twin of the communications network that the BLISK anomalies are identified ahead of time (and accordingly avoided), as well as the network being configured ahead of time to cater for the upcoming communication traffic demands in an efficient manner.

The above use case may be considered highly valuable to increase productivity in the highly demanded aviation industry and significantly reduce production cost in this multi-billion USD industry.

Based on the predicted QoE information from the second digital twin (BLISK digital twin), the network efficiency is predicted and it is checked whether the upcoming network related demands in the QoE information would be satisfied with the current network configuration. If the network efficiency is predicted to be below a certain acceptability threshold, a new network configuration is found using the first digital twin of the communications network that satisfies the upcoming network related demands.

### Autonomous Mobile Robot (AMR)

In this example, the first digital twin of the communications network is used to update the network configuration taking into considering the QoE information relating to an application that involved an AMR picking up an object from a first location and performing an operation such as installing a screw on it (see for example, J. Ansari et a. “5G enabled flexible lineless assembly systems with edge cloud controlled mobile robots”, in Proc. on IEEE PIMRC 2022. Online: https://ieeexplore.ieee.org/abstract/document/9977496).

In this example, if the communications network is able to provide a suitable level of communication service at the first location and/or over a first route to the first location during a first time period, the second network node instructs the AMR to go the first location during the first time period, carry out the pick-up operation on the workpiece and install the screw. It will be appreciated that the whole process may involve several messages to be exchanged between different sensors and controller, and between different actuators and controller.

Therefore, by utilizing the method of FIGS. 2 and 3, if the communications network is unable to provide a sufficient level of service (e.g. unable to meet a QoE requirement of the application) at the first location and/or over the first route during the first time period, the first digital twin evaluates other possible network configurations using internal logic such as radio network simulation, data-driven artificial intelligence process, statistical method or some other mechanism for network performance assessment and prediction.

Once a suitable network configuration is found that is able to meet the QoE requirements of the application, the first digital twin may communicate to the second digital twin that the AMR can perform its task at the first location and/or over the first route during the first time period.

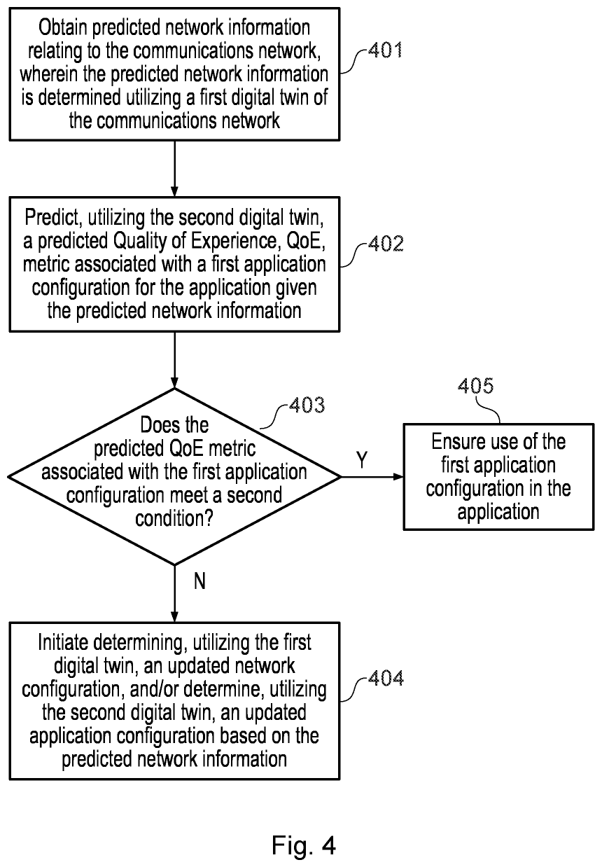

FIG. 4 illustrates a method 400 performed by a second network node wherein the second network node hosts second digital twin of an application, wherein the application utilizes a communications network.

The method 400 may be performed by a second network node, which may comprise a physical or virtual node, and may be implemented in a computing device or server apparatus and/or in a virtualized environment, for example in a cloud, edge cloud or fog deployment. The second network node may comprise the network node 101 of FIG. 1 hosting the second digital twin 105.

In step 401, the method comprises obtaining predicted network information relating for the communications network wherein the predicted network information is determined utilizing a first digital twin of the communications network.

The predicted network information may comprise one or more of: a predicted system capacity of the communications network, predicted throughput related information for the communication network, a map of a radio environment of the communications network, a predicted communication coverage map, a predicted achievable latency for the communications network, and a predicted achievable reliability of the communications network. It will be appreciated that the prediction network information may comprise any information relating to the communications network that can be predicted by the first digital twin for the communications network.

In step 402 the method comprises predicting utilizing the second digital twin, a Quality of Experience, QoE, metric associated with a first application configuration for the application given the predicted network information.

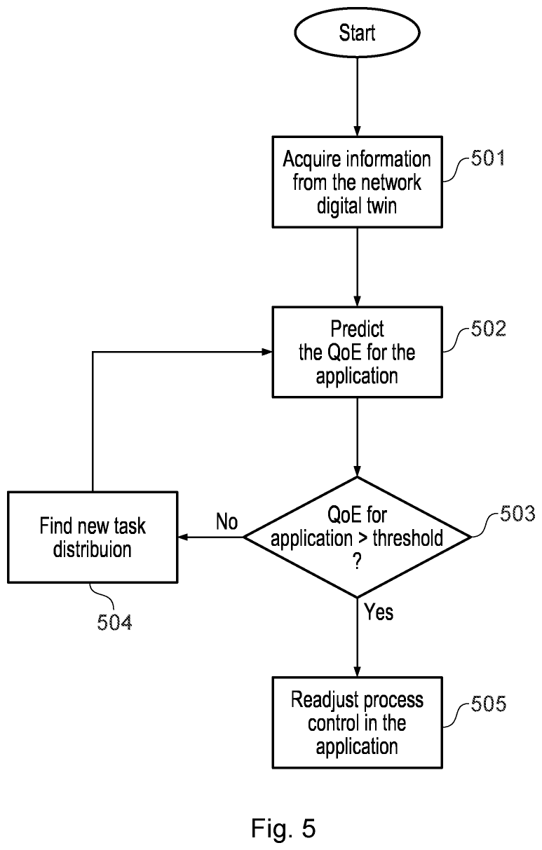

The first application configuration may comprise one or more settings for any factory assets/components or parameters for performing the application process of the application. For example, an application configuration may comprise locations for various AMRs, routes to be taken by AMRs, or any suitable configuration (e.g. velocities, data rates, etc.) of how various application processes are to be performed by the application. In some examples, the first application configuration comprises a current application configuration currently implemented in the application 103 (as will be described in more detail with reference to FIG. 5). However, in other examples, the application configuration may have already be updated in the second digital twin based on a trigger from the first digital twin, and the first application configuration may comprise an updated network configuration not currently implemented in the application 103 (as will be described in more detail with reference to FIG. 6).

It will be appreciated that a QoE metric may depend upon the application and is seen from the application perspective. One example of a QoE metric may be a frequency of interruptions to a production line. Interruptions may for example occur if maintenance is required. These interruptions may be seen in production lines where production line halts or slower production are seen as reduced QoE.

If the QoS provided by the communications network to the application is not good enough the QoE of the application may be degraded as a result. QoE degradation may reduce manufacturing efficiency and/or compromises the quality of produced goods.

It will be appreciated that there may be more complex functions defining the predicted QoE metric such as a weighted function of multiple QoE factors.

In step 402, the second digital twin takes into account the predicted network information when determining the predicted QoE metric.

Considering the example in which the QoE metric comprises a frequency of interruptions to a production line, should the predicted information indicate that there is a predicted increase in the latency provided by the communications network to a particular area of a factory during a particular time period, the second digital twin may factor this in when determining whether or not the QoE metric will be met during that time period. For example, it may be that the first application configuration configures the application to place a high proportion of the available AMRs within the particular area during the particular time period, and in this case the predicted increase in latency may have a significant affect on the predicted QoE metric. However, alternatively if the first application configuration configures the application to not place any AMRs within the particular area during the particular time period, then the predicted increase in the latency provided by the communications network may not have any affect on the predicted QoE metric.

In step 403 the method comprises determining whether the predicted QoE metric associated with the first application configuration meets a second condition.

For example, the second condition may comprise a condition that the frequency of interruptions to a production line is below a threshold frequency.

If in step 403 the predicted QoE metric does not meet the second condition, the method passes to step 404 in which one or more of the following is performed: initiating determining, utilizing the first digital twin, an updated network configuration, and/or determining, utilizing the second digital twin, an updated application configuration based on the predicted network information.

In some cases, the application configuration may be preferentially adjusted over adjusting the network configuration. In these examples, step 404 may comprise determining, utilising the second digital twin, an updated application configuration based on the predicted network information. For example, if the predicted frequency of interruptions to the production line is above the threshold frequency, step 404 may comprise determining an updated application configuration that avoids placing AMRs within the particular area during the particular time period or throttles down the amount of non-critical and/or background service data to be transmitted to the AMRs located within the particular area.

In other examples however, the network configuration may be preferentially adjusted over adjusting the application configuration. In these examples, step 404 may comprise initiating determining, utilizing the first digital twin, an updated network configuration. Step 404 in these examples may comprise providing an indication that the QoE metric will not be met in the application to the first digital twin. The first digital twin may then attempt to adjust the network configuration such that the QoE metric will be met in the application whilst utilizing the first application configuration.

Where the first digital twin and the second digital are hosted in different network nodes, the step of initiating determining, utilising the first digital twin, an updated network configuration may comprise the second network node transmitting a trigger to the first network node hosting the second digital twin.

In some examples, the step of determining utilizing the second digital twin, an updated application configuration based on the predicted network information is performed using a machine learning, ML, model.

If in step 403 the predicted QoE metric does meet the second condition, the method may pass to step 405 which comprises ensuring use of the first application configuration in the communications network. Where the first application configuration comprises a current application configuration, step 405 may comprise making no changes in response to the determination of step 403. However, where the first application configuration comprises an updated application configuration, step 405 may comprise initiating updating the current application configuration of the application to the first application configuration.

FIG. 5 illustrates an example implementation of the method of FIG. 4. In particular, FIG. 5 illustrates an example in which the interaction between the first digital twin and the second digital twin allows for configuring of the application configuration as per the predicted network information.

In step 501 the second network node obtains predicted network information for the communications network wherein the predicted network information is determined utilising a first digital twin of the communications network. Step 501 comprises an example implementation of step 401. For example, the first digital twin may indicate to the second digital twin the network capabilities and performance levels to be expected ahead of time in the digital space.

In step 502 the second network node predicted, utilising the second digital twin, a predicted QoE metric of a current applications configuration for the application given the predicted network information. Step 502 comprises an example implementation of step 402 of FIG. 4.

In step 503, the second network node determines whether the predicted QoE metric meets a second condition. In the examples, the second condition comprises a threshold condition.

If the predicted QoE metric does not meet the second condition, the method passes to step 504 in which an updated application configuration is determined. For example, the updated application configuration may comprise a new process task distribution for the application. A process task distribution, for instance, may comprise the manufacturing operations performed by each component in the factory based, for example, on the sensor inputs decided by a controller.

The method then returns to step 502 in which the second network node predicts utilizing the second digital twin, a predicted QoE metric of the updated application configuration. In step 503, the second network node determines whether the predicted QoE metric of the updated application configuration meets the second condition.

If the predicted QoE metric of the updated application configuration meets the second condition given the predicted network information, the method passes to step 505 in which the second network node initiates use of the updated application configuration in the application. For example, the process task distribution in the application may be updated to If the predicated QoE metric of the updated application configuration does not meet the second condition, the method passes back to step 504 and a new updated application configuration is determined.

If will be appreciated that the loop around steps 502, 503 and 504 may continue until a suitable network configuration (e.g. one for which the predicted QoE metric meets the second condition) is found, or until a counter (counting the number of iterations of the loop that have been performed) reaches a threshold value.

It will be appreciated that the second network node may in some examples opt not to apply an updated application configuration that meets the second condition if, for example, the updated application configuration is considered too costly to the second network node in some manner. For example, the second condition may relate to a frequency of interruptions in a production line, but the updated application configuration may be costly with regards to some other QoE metric, for example, a volume of produced goods.

The process of FIG. 5 allows for the prediction of a QoE metric for the application given a current application configuration. If the QoE for the application predicted to meet the second condition (e.g. that the QoE metric is above a certain threshold which may be custom defined and/or user configurable), the processes of the application may be adjusted (for example, distributed in time and/or space) accordingly. If the QoE metric for the application is found not to satisfy the second condition, a new application configuration may be identified. Subsequently, the QoE metric of the application is predicted with the new application configuration and if this satisfies the second condition, the new application configuration may be applied to the application.

In the following, an example (extended reality (XR) application) of how the digital twin interaction logic of FIGS. 4 and 5 may be applied for network configuration and for application process control.

### XR

In an XR (extended reality) collaborative application on a factory shopfloor workers wearing head mounted XR devices may be directed to perform certain (manufacturing/maintenance) tasks on machines in a production environment and inside processing plants in real time.

The XR devices may also stream live video feed of the environment (e.g. plant and machine parts) and/or other sensed data to a cloud-based controller.

Based on the predicted network information relating to a given location in the environment provided by the first digital twin, the second digital twin may be update an application configuration such that tasks are accordingly assigned to workers/machines/robots which lead to specific application traffic requirements. For example, if the network coverage in a particular part of the environment is due to be low, the second digital twin may ensure that the application configuration is updated such that the number of workers/machines/robots in that part of the environment is low enough. The updated application configuration may be determined to respect the interdependencies and availability of raw material used in the application process and factory resources (e.g. machines, tools, robots or computer resources for analysis/control etc.). Collaborative task distribution is performed by the second digital twin involving one or more workers and machines (as envisioned by EU Industry 5.0 initiative of human-in-the-loop production), and is based on the predicted application QoE given specific network efficiency.

In embodiments described herein the interaction between the first digital twin and the second digital twin allows for the prediction of one or more of: the network quality and the QoE of the application. Embodiments may then enable the execution of “what/if” type simulations ahead in time to adaptively tune the network configuration as shown in 3 and/or the application configuration (e.g. task distribution) as presented in FIG. 5.

In some examples, the method of FIGS. 2 and 4 a system comprising a first digital twin and a second digital twin may be configured to execute both the method of FIG. 2 and the method of FIG. 4. An example of how this may be implemented is illustrated in FIG. 6.

FIG. 6 illustrates an example implementation of the methods of FIGS. 2 and 4. The elements of the system of FIG. 1 namely the application 103, the first network node hosting the first digital twin 104, the second network node hosting the second digital twin 105 and the communications network 102 are utilised to provide the example implementation of the methods of FIGS. 2 and 4 in the signalling diagram of FIG. 6. As illustrated in FIG. 1 it will be appreciated that the first network node and the second network node may be the same network node (e.g. the first digital twin 104 and the second digital twin 105 may be hosted by a single network node).

In particular, FIG. 6 illustrates a non-limiting example signaling diagram where the interaction and mutual re-configuration of the first digital twin and the second digital twin allows for the application to satisfy a QoE requirement.

In step 601 the method comprises the first network node providing predicted network information obtained through the first digital twin to the second network node. Step 601 comprises an example implementation of step 401 of FIG. 4 or step 501 of FIG. 5. In step 602 the second network node utilizes the second digital twin to predict a QoE metric of the application given a current application configuration and the predicted network information. Step 602 comprises an example implementation of step 402 of FIG. 4 and step 502 of FIG. 5.

In step 603 the second network node determined whether the QoE metric meets first threshold condition. Step 603 comprises an example implementation of step 403 of FIG. 4 and step 503 of FIG. 5.

If the QoE metric meets the first threshold condition, the second network node ensures in step 604 that the application continues to implement the current application configuration. Furthermore, if the predicted network information acquired from the first digital twin (e.g. relating to network capability and expected KPIs) causes the predicted QoE metric to satisfy first threshold condition for the application (and the current application configuration), the current network configuration maintained in the network. Step 604 comprises an example implementation of step 405 of FIG. 4.

If the QoE metric does not meet the first threshold condition, the second network node determines in step 605 whether this issue is to be address by triggering the first digital twin to update the network configuration. This decision may be made based on a comparison of QoE requirements of the application with a QoE metric that is achievable with the current network configuration.

If the issue of the QoE metric not meeting the first threshold condition is to be addressed by triggering the first digital twin, the first network node in step 606 initiates determining, utilizing the first digital twin, an updated network configuration. Step 606 may comprise providing, to the first digital twin, a prediction that, given a current network configuration, the application will not fulfil a QoE requirement of the application. Step 606 may also comprise transmitting predicted QoE information relating the to the current application configuration to the first network node.

Step 606 comprises an example implementation of step 201 of FIG. 2.

In step 607 the first network node utilizes the first digital twin to determine an updated network configuration.

In step 608, the first network node predicts a predicted network efficiency of the updated network configuration for the communications network given the QoE information. In other words, if the current network configuration fails to enable the application to produce a predicted QoE metric that satisfies the first threshold condition, an updated network configuration is determined.

In step 609 the first network node determines whether the predicted network efficiency meets a second threshold condition. Step 609 comprises an example implementation of step 203 of FIG. 2.

If the predicted network efficiency does not meet the second threshold condition, the method passes back to step 607 and a new updated network configuration is found.

If the predicted network efficiency does meet the second threshold condition, the method passes to step 610 in which the first network node ensures use of the updated network configuration in the communications network. Step 610 comprises an example implementation of step 205 of FIG. 2.

If will be appreciated that in some circumstances no suitable network configuration can be found. For example, there may be a limited number of times the flop around steps 607, 608 and 609 can be performed before it is determined that no suitable network configuration can be found. If no suitable network configuration can be found the method passes to step 612 in which the first network node initiating determining, utilizing the second digital twin, an updated application configuration of the application. For example, step 612 may comprise the first network node notifying the second network node to check for an updated application configuration. This may occur when, for example, the first threshold condition for the QoE metric is very high and the network is physically unable to provide a network configuration that will enable the application to fulfil it.

The second network node then in step 613 determines an updated application configuration utilizing the second digital twin.

In step 614, the second network node predicts a predicted QoE metric associated with the updated application configuration.

In step 615 the second network node determines whether the predicted QoE metric meets the first threshold condition.

If the QoE metric does not meet the first threshold condition the method passes back to step 613 and a new updated application configuration is determined.

If the predicted QoE metric meets the first threshold condition the method passes to step 616 in which the first network node ensures that the updated application configuration is used in the application. In other words, if the network cannot be updated to enable the application to produce a predicted QoE metric that meets the first threshold condition, the application configuration (e.g. task distribution) for the application may be updated to an updated application configuration associated with less challenging QoE requirements, e.g., in time or space.

Returning to step 605, if it is determined that the issue is not to be addressed by updating the network configuration the method passes straight to step 613 and the application configuration is updated instead.

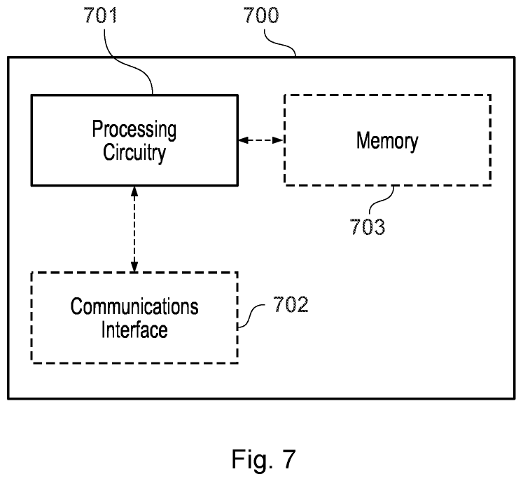

FIG. 7 illustrates an network node 700 comprising processing circuitry (or logic) 701. The processing circuitry 701 controls the operation of the network node 700 and can implement the method described herein in relation to an network node 700. The processing circuitry 701 can comprise one or more processors, processing units, multi-core processors or modules that are configured or programmed to control the network node 700 in the manner described herein. In particular implementations, the processing circuitry 701 can comprise a plurality of software and/or hardware modules that are each configured to perform, or are for performing, individual or multiple steps of the method described herein in relation to the network node 700. It will be appreciated that the network node 700 may comprise one or more virtual machines running different software and/or processes. The network node 700 may therefore comprise, or be implemented in or as one or more servers, switches and/or storage devices and/or may comprise cloud computing infrastructure that runs the software and/or processes.

Briefly, the processing circuitry 701 of the network node 700 is configured to perform the method as described herein with reference to a network node (e.g. a first network node or a second network node or both).

In some embodiments, the network node 700 may optionally comprise a communications interface 702. The communications interface 702 of the network node 700 can be for use in communicating with other nodes, such as other virtual nodes. For example, the communications interface 702 of the network node 700 can be configured to transmit to and/or receive from other nodes requests, resources, information, data, signals, or similar. The processing circuitry 701 of network node 700 may be configured to control the communications interface 702 of the network node 700 to transmit to and/or receive from other nodes requests, resources, information, data, signals, or similar. The communications interface 702 can use any suitable communication technology.

Optionally, the network node 700 may comprise a memory 703. In some embodiments, the memory 703 of the network node 700 can be configured to store program code that can be executed by the processing circuitry 701 of the network node 700 to perform the method described herein in relation to the network node 700. Alternatively or in addition, the memory 703 of the network node 700, can be configured to store any requests, resources, information, data, signals, or similar that are described herein. The processing circuitry 701 of the network node 700 may be configured to control the memory 703 of the network node 700 to store any requests, resources, information, data, signals, or similar that are described herein. The network node 700 may be configured operate in the manner described herein in respect of an network node.

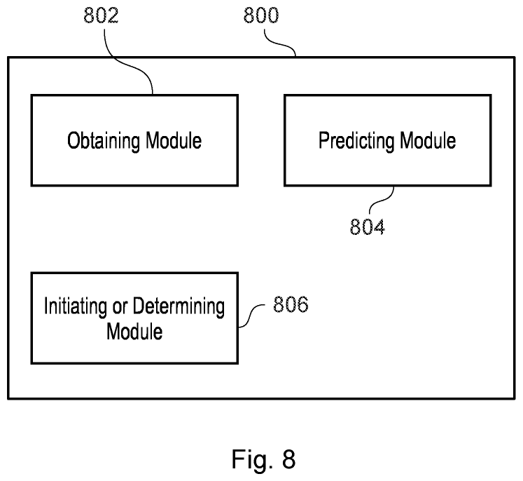

FIG. 8 is a block diagram illustrating a first network node 800 according to some embodiments. The first network node 800 is configured to host a first digital twin of a communications network, wherein an application is configured to utilize the communications network to operate. The first network node 800 comprises an obtaining module 802 configured to obtain predicted Quality of Experience, QoE, information for the application, wherein the predicted QoE information is determined utilizing a second digital twin of the application. The first network node 800 comprises a predicting module 804 configured to predict (202), utilizing the first digital twin, a predicted network efficiency of a first network configuration for the communications network given the QoE information. The first network node further comprises a initiating or determining module 806 configured to responsive to the predicted network efficiency of the first network configuration not meeting a first condition: initiate determining, utilizing the second digital twin, an updated application configuration, and/or determine, utilizing the first digital twin, an updated network configuration based on the predicted QoE information. The first network node 800 may operate in the manner described herein in respect of an first network node.

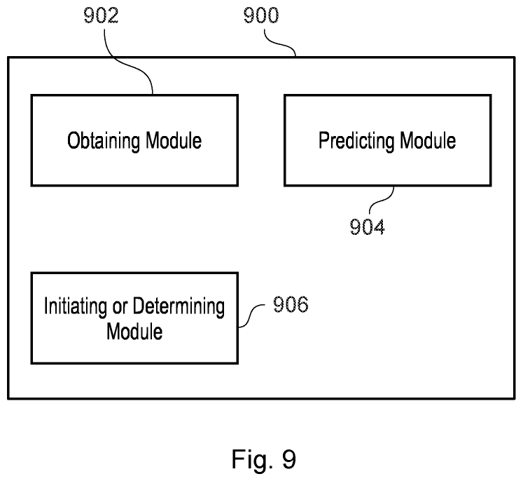

FIG. 9 is a block diagram illustrating a second network node 900 according to some embodiments. The second network node 900 is configured to host a second digital twin of an application, wherein the application is configured to utilize a communications network to operate. The second network node 900 comprises an obtaining module 902 configured to obtain predicted network information relating to the communications network, wherein the predicted network information is determined utilizing a first digital twin of the communications network. The second network node 900 comprises a predicting module 904 configured to predict, utilizing the second digital twin, a predicted Quality of Experience, QoE, metric associated with a first application configuration for the application given the predicted network information. The second network node further comprises an initiating or determining module 906 configured to responsive to the predicted QoE metric not meeting a second condition: initiate determining, utilizing the first digital twin, an updated network configuration, and/or determine, utilizing the second digital twin, an updated application configuration based on the predicted network information. The second network node 900 may operate in the manner described herein in respect of a second network node.

There is also provided a computer program comprising instructions which, when executed by processing circuitry (such as the processing circuitry 701 of the network node 700 described earlier), cause the processing circuitry to perform at least part of the method described herein. There is provided a computer program product, embodied on a non-transitory machine-readable medium, comprising instructions which are executable by processing circuitry to cause the processing circuitry to perform at least part of the method described herein. There is provided a computer program product comprising a carrier containing instructions for causing processing circuitry to perform at least part of the method described herein. In some embodiments, the carrier can be any one of an electronic signal, an optical signal, an electromagnetic signal, an electrical signal, a radio signal, a microwave signal, or a computer-readable storage medium.

Embodiments described herein may enable network resource optimization and enhanced network performance. The interaction between the first digital twin and the second digital twin allows for the prediction of the communication service demands. This helps to apply a network configuration that meets the (upcoming) factory application demands and to increase network performance such as enhanced throughput, decreased latency, enhanced reliability, efficient spectrum utilization, lower energy footprint, etc.

Embodiments described herein may enable increased Quality of Experience (QoE) for the application, e.g., factory processes where the network services can be utilized more efficiently. Based on the capabilities of the network, the factory application can adjust its communication demand.

Embodiments described herein enable an increase in production efficiency. With better utilization of communication services through predictive processes, the production processes may be adjusted in a manner to increase production efficiency. One simple example is that the second digital twin of the application may communicate to the first digital twin of the communications network information relating to an upcoming manufacturing task, thereby allowing the first digital twin to proactively configure the network in a manner that satisfies the communication demands of the application in an effective manner leading to enhanced production efficiency.

Embodiments described herein also enable proactive fault avoidance: The interaction between the first digital twin and the second digital twin allows for the prediction of potential errors and faults in the application processes as well as the communication system deficiencies. Moreover, joint simulation allows for the finding of potential network configuration and adjustment of manufacturing processes to proactively avoid the anomaly.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-37. (canceled)

38. A first network node, wherein the first network node is configured to host a first digital twin of a communications network, wherein an application is configured to utilize the communications network to operate, the first network node comprising:
memory; and
processing circuitry configured to cause the first network node to:
obtain predicted Quality of Experience (QoE) information for the application, wherein the predicted QoE information is determined utilizing a second digital twin of the application;
predict, utilizing the first digital twin, a predicted network efficiency of a first network configuration for the communications network given the QoE information; and
responsive to the predicted network efficiency of the first network configuration not meeting a first condition:
initiate determining, utilizing the second digital twin, an updated application configuration, and/or
determine, utilizing the first digital twin, an updated network configuration based on the predicted QoE information.

39. The first network node of claim 38, wherein
the processing circuitry is further configured to cause the first network node to, responsive to the network efficiency of the first network configuration meeting the first condition, ensure use of the first network configuration in the communications network.

40. The first network node of claim 38, wherein
the first network configuration comprises a current network configuration.

41. The first network node of claim 38, wherein
the predicted QoE information comprises a prediction that, given a current network configuration, the application will not fulfil a QoE requirement of the application.

42. The first network node of claim 38, wherein
determining, utilizing the first digital twin, the updated network configuration comprises determining an updated network configuration that is predicted to fulfil the QoE requirement.

43. The first network node of claim 38, wherein
the predicted QoE information comprises:
a predicted network traffic profile for the application,
one or more Quality of Service (QoS) requirements of the application,
a prediction of number of devices,
a prediction of number of connections to the communications network within the application,
a predicted location of devices within the application,
a predicted mobility pattern of one or more devices within the application, and/or one or more planned changes to the application.

44. The first network node of claim 38, wherein
the processing circuitry is further configured to cause the first network node to:
predict utilizing the first digital twin, a network efficiency of the updated network configuration;
responsive to the network efficiency of the updated network configuration meeting the first condition given the predicted QoE information, initiate use of the updated network configuration in the communications network; and
responsive to the network efficiency of the updated network configuration not meeting the first condition, determine a new updated network configuration.

45. The first network node of claim 38, wherein
the processing circuitry is further configured to cause the first network node to, responsive to being unable to find a network configuration that meets the first condition given the predicted QoE information, perform the step of initiating determining, utilizing the second digital twin, the updated application configuration of the application.

46. The first network node of claim 38, wherein
the processing circuitry is further configured to cause the first network node to provide predicted network information to the second digital twin.

47. The first network node of claim 38, wherein
the network efficiency comprises: a resource utilization efficiency and/or one or more key performance indicators.

48. The first network node of claim 38, wherein
the first condition is user defined or application dependent.

49. A second network node, wherein the second network node is configured to host second digital twin of an application, wherein the application is configured to utilize a communications network to operate, the second network node comprising:
memory; and
processing circuitry configured to cause the second network node to:
obtain predicted network information relating to the communications network, wherein the predicted network information is determined utilizing a first digital twin of the communications network;
predict, utilizing the second digital twin, a predicted Quality of Experience (QoE) metric associated with a first application configuration for the application given the predicted network information; and
responsive to the predicted QoE metric not meeting a second condition:
initiate determining, utilizing the first digital twin, an updated network configuration, and/or
determine, utilizing the second digital twin, an updated application configuration based on the predicted network information.

50. The second network node of claim 49, wherein
the processing circuitry is further configured to cause the second network node to, responsive to the QoE metric of the first application configuration meeting the second condition, ensure use of the first application configuration in the application.

51. The second network node of claim 49, wherein
the first application configuration comprises a current application configuration.

52. The second network node of claim 49, wherein
the predicted network information comprises:
a predicted system capacity of the communications network,
predicted throughput related information for the communication network,
a map of a radio environment of the communications network,
a predicted communication coverage map,
a predicted achievable latency for the communications network, and/or
a predicted achievable reliability of the communications network.

53. The second network node of claim 49, wherein
the processing circuitry is further configured to cause the second network node to responsive to determining, utilizing the second digital twin, the updated application configuration based on the predicted network information:
predict utilizing the second digital twin, a QoE metric of the updated application configuration;
responsive to the QoE metric of the updated application configuration meeting the second condition given the predicted network information, initiate use of the updated application configuration in the application; and
responsive to the QoE metric of the updated application configuration not meeting the second condition, determine a new updated application configuration.

54. The second network node of claim 49, wherein
initiating determining, utilizing the first digital twin, an updated network configuration comprises providing, to the first digital twin, a prediction that, given a current network configuration, the application will not fulfil a QoE requirement of the application.

55. The second network node of claim 49, wherein
the processing circuitry is further configured to cause the second network node to provide predicted QoE information to the first digital twin.
